(19) United States
(12) Patent Application Publication
(10) Pub. No.: US 2024/0328443 A1
(43) Pub. Date: Oct. 3, 2024

(54) LOCKING DEVICE AND LOCKING SYSTEM

(71) Applicant: TOYOTA BOSHOKU KABUSHIKI KAISHA, Aichi (JP)

(72) Inventors: Seiya NISHIMURA, Okazaki-shi (JP); Hiroshi TSUJI, Nagoya-shi (JP); Fumitoshi AKAIKE, Miyoshi-shi (JP); Hajime TAKAGI, Toyoake-shi (JP)

(73) Assignee: TOYOTA BOSHOKU KABUSHIKI KAISHA, Aichi (JP)

(21) Appl. No.: 18/602,442

(22) Filed: Mar. 12, 2024

(30) Foreign Application Priority Data
Mar. 30, 2023 (JP) 2023-055419

(51) Int. Cl. F16B 2/10; F16B 2/22

(52) U.S. Cl. CPC F16B 2/10; F16B 2/22

(57) ABSTRACT

A locking device includes a contact part that is located on a side opposite to a locking protrusion across a locking wire and that comes into contact with the locking wire in an insertion direction in a state where an insertion portion is inserted through a space, the locking protrusion being contactable with the locking wire in a direction opposite to the insertion direction by being displaced with respect to a pivot arm.

### CROSS-REFERENCE TO RELATED APPLICATIONS

This application claims the benefit of Japanese Patent Application No. 2023-055419 filed on Mar. 30, 2023 with the Japan Patent Office, the entire disclosure of Japanese Patent Application No. 2023-055419 is incorporated herein by reference.

### BACKGROUND

The present disclosure relates to a locking device capable of fixing an article to a floor, a wall, or the like.

For example, a cart disclosed in Japanese Utility Model Registration No. 2605453 is not capable of fixing an article to a floor, a wall, or the like while carrying the article placed on the cart.

### SUMMARY

The present disclosure discloses an example of a locking device capable of fixing an article, a cart, or the like to a floor, a wall, or the like and inhibiting the article from greatly rattling at a time of fixation.

Desirably, a locking device lockable with a locking wire that is fixed to a fixing portion and that includes a portion arranged in a position spaced apart from the fixing portion comprises, for example, at least one element of the following constituent elements.

More specifically, the constituent elements comprise an insertion portion configured to be inserted through a space between the locking wire and the fixing portion, a pivot arm configured, in a state where the insertion portion is inserted through the space, to be located on a side opposite to the insertion portion across the locking wire and to extend parallel to an insertion direction of the insertion portion, the pivot arm being pivotable such that a leading end side of the pivot arm in extending directions thereof moves in directions to come closer to and to move away from the insertion portion, a locking protrusion that is provided on a leading end side of the pivot arm and that protrudes toward the insertion portion, the locking protrusion being displaceable in directions parallel to extending directions of the pivot arm, a shaft configured to be located on a side opposite to the locking protrusion across the locking wire in the state where the insertion portion is inserted through the space, the shaft supporting the pivot arm in a pivotable manner, and a contact part configured, in the state where the insertion portion is inserted through the space, to be located on the side opposite to the locking protrusion across the locking wire and to come into contact with the locking wire in the insertion direction, wherein the locking protrusion is contactable with the locking wire in a direction opposite to the insertion direction by being displaced with respect to the pivot arm.

Thus, according to the locking device, the locking wire may be held by the locking protrusion and the contact part. Further, the locking protrusion is contactable with the locking wire in the direction opposite to the insertion direction by being displaced with respect to the pivot arm. Therefore, the locking wire is held securely by the locking protrusion and the contact part, and thus rattling can be inhibited.

The locking device may be configured as described below.

More specifically, it is desirable that the locking protrusion is provided with, on a leading end side thereof in a protruding direction thereof, a tapered portion protruding toward the contact part. The tapered portion is engaged with the locking wire, and thus the pivot arm is restricted from pivoting in a direction in which the leading end side of the pivot arm moves far away from the insertion portion. This can lead to a reliable reduction in rattling.

In the present configuration, it is desirable that the insertion portion is provided with a groove that allows the tapered portion to be fitted therein.

Furthermore, it is desirable that the pivot arm comprises an abutment portion contactable with the locking wire, and the abutment portion is configured to come into contact with the locking wire from the side opposite to the insertion portion across the locking wire in the state where the insertion portion is inserted through the space.

Thus, the locking wire may be held by the pivot arm, that is, the abutment portion, and the insertion portion in a direction intersecting the extending directions of the pivot arm, and held by the locking protrusion and the contact part in the extending directions of the pivot arm. Therefore, an occurrence of rattling can be reliably inhibited.

### BRIEF DESCRIPTION OF THE DRAWINGS

An example embodiment of the present disclosure will be described hereinafter by way of example with reference to the accompanying drawings, in which:

FIG. 1 is a diagram showing an in-use state of a locking device according to a first embodiment;

FIG. 2 is a diagram of a locking wire;

FIG. 3 is a diagram of the locking device according to the first embodiment;

FIG. 4 is an exploded view of the locking device according to the first embodiment;

FIG. 5 is an explanatory diagram showing an in-use state of the locking device according to the first embodiment;

FIG. 6 is an explanatory diagram showing an in-use state of the locking device according to the first embodiment;

FIG. 7 is a diagram of the locking device according to the first embodiment;

FIG. 8 is a diagram of a structure of the locking device according to the first embodiment; and

FIG. 9 is a diagram of the structure of the locking device according to the first embodiment.

### DETAILED DESCRIPTION OF EXEMPLARY EMBODIMENTS

Embodiments of the present disclosure explained hereinafter show examples of embodiments that belong to the technical scope of the present disclosure. Matters to specify the invention recited in the claims are not limited to specific configurations or structures shown in the embodiments explained hereinafter.

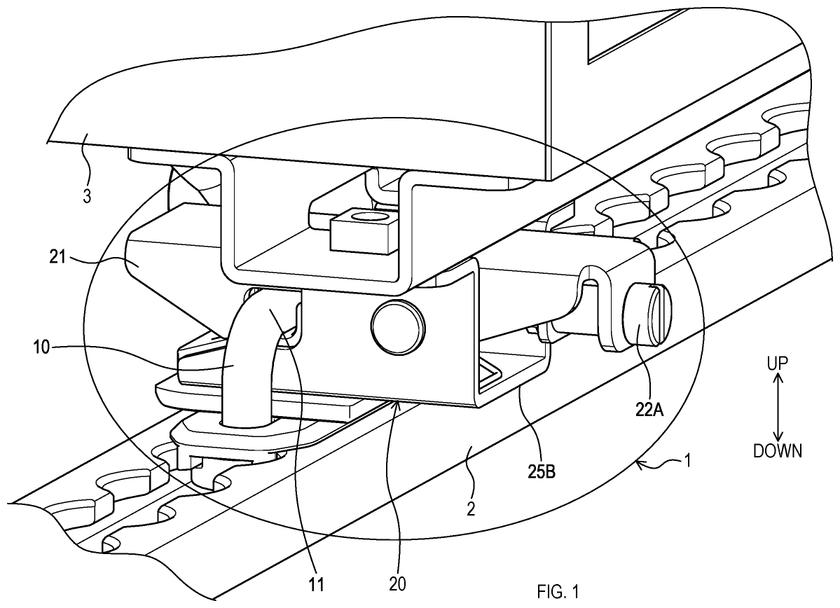

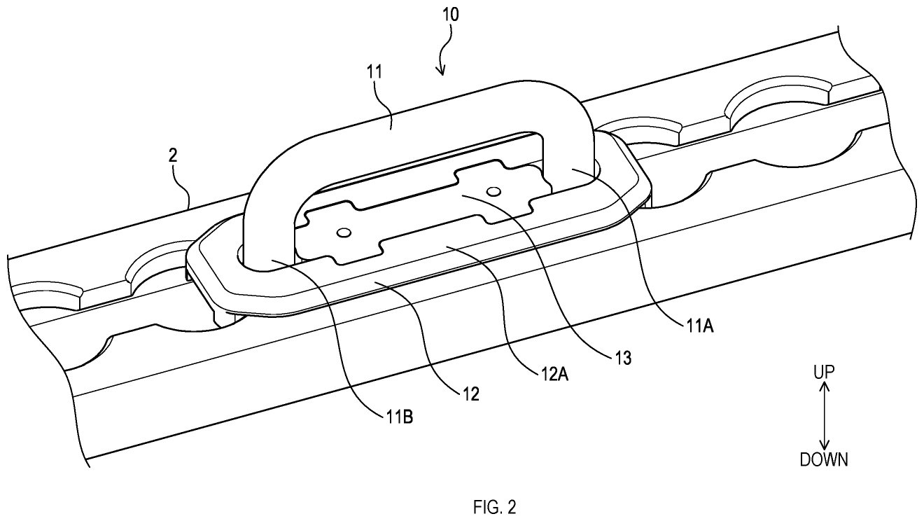

As shown in FIG. 1, the present embodiment is an example of applying a locking device and a locking system, according to the present disclosure, to a locking system 1 utilizing a stud fitting 10. The stud fitting 10 is an example of an attachment used for a fixing rail 2, as shown in FIG. 2.

The stud fitting 10 comprises a locking wire 11 and an engagement portion 12. The locking wire 11 is a member having a portion arranged in a position spaced apart from the engagement portion 12, and fixed to the engagement portion 12.

Specifically, the locking wire 11 is a bar-shaped member extending parallel to the fixing rail 2. Coupling portions 11A and 11B that couple the locking wire 11 to the engagement portion 12 are respectively provided at one end and the other end of the locking wire 11 in a longitudinal direction.

The engagement portion 12 is an example of a fixing portion that couples and fixes the locking wire 11 to the fixing rail 2. The engagement portion 12 can switch between an immovable state and a movable state with respect to the fixing rail 2.

Directional arrows, oblique lines, and others in each figure are described to facilitate understanding of the relationship between the figures and of the shape of each member or portion. Therefore, the locking system 1 is not limited by the directions described in each figure.

For at least a member or portion described with a reference numeral affixed thereto, there is at least one member or portion unless specified as “only one” or the like. The locking system 1 described in the present disclosure comprises at least one of elements such as at least members and portions described with reference numerals or structural portions shown in the drawings.

### First Embodiment

### 1. Outline of Locking System

As shown in FIG. 1, the locking system 1 according to the present embodiment is applied to a fixing structure in which a fixing rail 2 is fixed to a vehicle such as a car, and an article 3 is fixed to the fixing rail 2. In other words, the locking system 1 is a fixing structure for fixing an article 3 to a vehicle.

The article 3 according to the present embodiment is integrated with a cart comprising a wheel such as a caster. Thus, the fixing rail 2 shown in FIG. 1 is embedded in and fixed to a floor of the vehicle. The fixing rail 2 according to the present embodiment is, for example, Airline Rail (registered trademark).

### 2. Locking System (Specifically, Configuration of Locking Device)

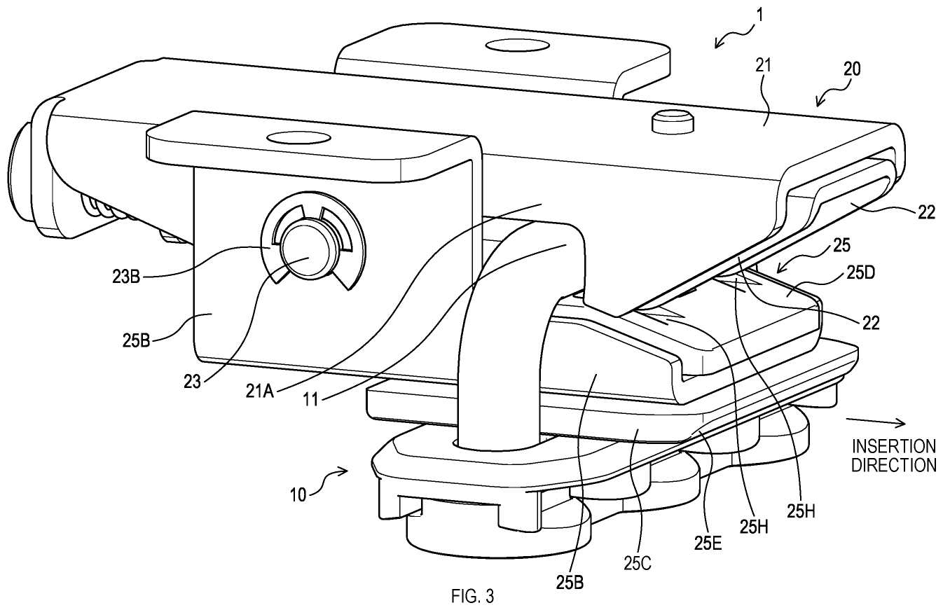

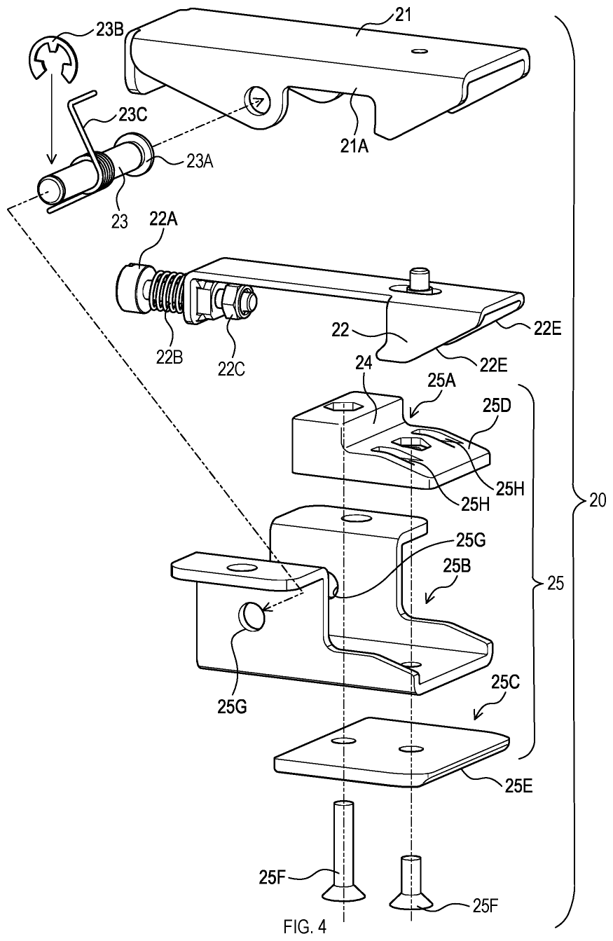

As shown in FIG. 3, the locking system 1 comprises a stud fitting 10 and a locking device 20. As shown in FIG. 4, the locking device 20 comprises at least a pivot arm 21, a locking protrusion 22, a shaft 23, and an insertion portion 25.

### <Insertion Portion>

The insertion portion 25 is a portion to be inserted through a space 13 (see FIG. 2) between the locking wire 11 and the engagement portion 12 (see FIG. 3). As shown in FIG. 4, the insertion portion 25 comprises an insertion main body 25A, a bracket 25B, and a slider 25C.

The insertion main body 25A is a block made of a resin. The insertion main body 25A is provided with, on a leading end side thereof in an insertion direction (in FIG. 4, a right side), a tapered portion 25D having an inclined surface. The bracket 25B is a member made of a metal, and is an attachment portion for fixing the insertion portion 25 to a lower surface of the article 3.

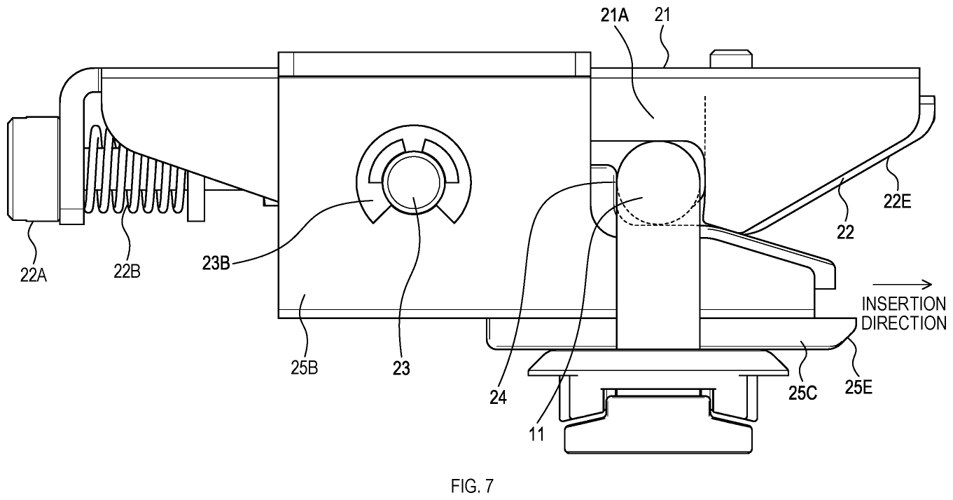

As used herein, the “insertion direction” indicates a direction in which the insertion portion 25 moves to be inserted through the space 13 (a direction of an arrow in FIG. 7). Thus, the leading end side of the insertion main body 25A in the insertion direction is a right end side of the insertion main body 25A in FIG. 4.

The slider 25C is a portion that is brought into sliding contact with an upper surface 12A of the engagement portion 12 (see FIG. 2) when the insertion portion 25 is inserted through the space 13. For this, the slider 25C is provided with, on a leading end side thereof in the insertion direction, a tapered portion 25E inclined in a direction opposite to that of the tapered portion 25D.

In other words, a leading end side of the insertion portion 25 in the insertion direction is configured by the tapered portion 25D and the tapered portion 25E as a tapered part having a wedge shape with a cross-sectional area reducing toward the leading end. The insertion main body 25A and the slider 25C are fastened to each other with screws 25F in a state where the bracket 25B is interposed therebetween.

As shown in FIG. 4, the insertion main body 25A is provided with a contact part 24. The contact part 24 is a portion located on a side opposite to the locking protrusion 22 across the locking wire 11 in a state where the insertion portion 25 is inserted through the space 13 (see FIG. 7).

The contact part 24 comes into contact with the locking wire 11 in the insertion direction. That is, in FIG. 7, the insertion direction is a direction from a left side to a right side. Therefore, the contact part 24 comes into contact with the locking wire 11 from the left side in FIG. 7, and the locking protrusion 22 comes into contact with the locking wire 11 from the right side in FIG. 7.

### <Pivot Arm and Shaft>

As shown in FIG. 3, the pivot arm 21 is a member located on a side opposite to the insertion portion 25 across the locking wire 11 in the state where the insertion portion 25 is inserted through the space 13. The pivot arm 21 extends parallel to the insertion direction. The pivot arm 21 can pivot such that a leading end side of the pivot arm 21 in its extending directions moves in directions to come closer to and to move away from the insertion portion 25 (up-down directions in FIG. 3).

Specifically, the shaft 23 is a shaft supporting the pivot arm 21 in a pivotable manner. In the state in which the insertion portion 25 is inserted through the space 13, the shaft 23 is arranged on the side opposite to the locking protrusion 22 across the locking wire 11, and also on a side opposite to the locking protrusion 22 across the contact part 24.

Accordingly, the pivot arm 21 can pivot such that the leading end side of the pivot arm 21 in the extending directions moves in the directions to come closer to and to move away from insertion portion 25. As shown in FIG. 4, the locking device 20 is provided with a spring 23C. The spring 23C exerts an elastic force in a direction in which the leading end side of the pivot arm 21 in the extending directions moves in the direction to come closer to the insertion portion 25.

The shaft 23 is inserted into a shaft hole 25G of the bracket 25B. The shaft 23 is provided with a retaining flange 23A on one end side in a longitudinal direction thereof. The shaft 23 is provided with an E-shaped retaining ring 23B mounted on the other end side thereof.

As shown in FIG. 3, the pivot arm 21 comprises an abutment portion 21A contactable with the locking wire 11. In the state where the insertion portion 25 is inserted through the space 13, the abutment portion 21A comes into contact with the locking wire 11 from the side opposite to the insertion portion 25 across the locking wire 11.

Specifically, for example, referring to FIG. 7, the abutment portion 21A comes into contact with the locking wire 11 from above, and the insertion portion 25 comes into contact with the locking wire 11 from below. In other words, in the state where the insertion portion 25 is inserted through the space 13, the locking wire 11 is held by the insertion portion 25 and the abutment portion 21A in the up-down directions.

The abutment portion 21A according to the present embodiment is provided on each of one end side and the other end side of the pivot arm 21 along a pivot axis direction. The pivot axis direction coincides with a direction parallel to an axial direction of the shaft 23, or is a direction parallel to the locking wire 11.

### <Locking Protrusion>

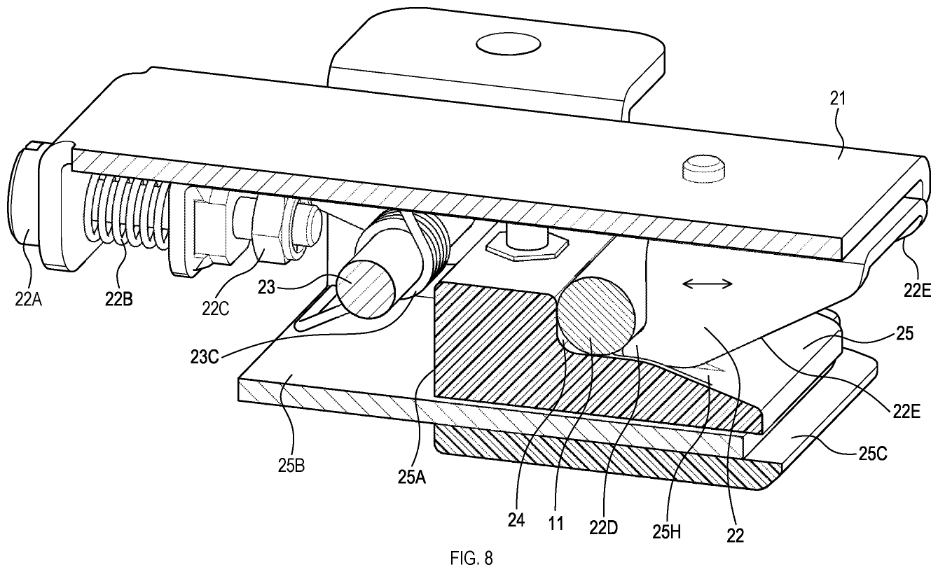

As shown in FIG. 8, the locking protrusion 22 is a portion that is provided on a leading end side of the pivot arm 21 in its extending directions, and that protrudes toward the insertion portion 25. Thus, in the present embodiment, the pivot arm 21 and the locking protrusion 22 form a “hook-shaped member”.

The locking protrusion 22 can be displaced in the extending directions of the pivot arm 21 (directions of a double-headed arrow in FIG. 8). A displacement of the locking protrusion 22 with respect to the pivot arm 21 allows the locking protrusion 22 to come into contact with the locking wire 11 in a direction opposite to the insertion direction (i.e., from a right side of FIG. 8).

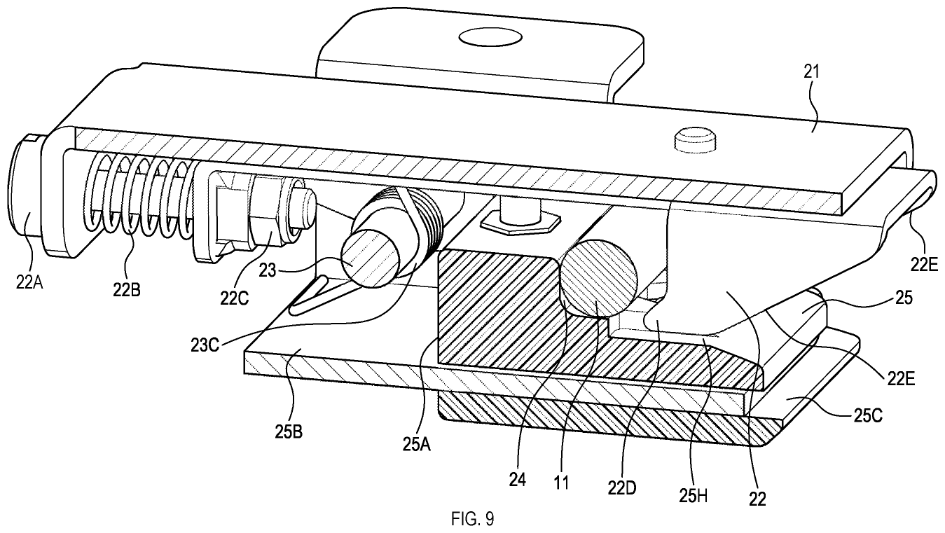

This causes the locking wire 11 to be held by the locking protrusion 22 and the contact part 24 in the extending directions of the pivot arm 21 (see FIG. 8). FIG. 9 shows a state where the locking protrusion 22 is spaced apart from the locking wire 11.

In the present embodiment, the locking protrusion 22 is displaced in conjunction with rotation of a position adjustment bolt 22A. A spring 22B exerts an elastic force in a direction in which the locking protrusion 22 moves away from the contact part 24. A nut 22C controls a maximum distance between the locking protrusion 22 and the contact part 24.

The locking protrusion 22 is provided with, on a leading end side thereof in a protruding direction thereof (a lower end side of the locking protrusion 22 in FIG. 9), a tapered portion 22D. The tapered portion 22D is a triangle-like portion protruding toward the contact part 24, that is, the locking wire 11.

Furthermore, the insertion portion 25 (in the present embodiment, the insertion main body 25A) is provided with a groove 25H in which the tapered portion 22D can be fitted, as shown in FIG. 4. Thus, in the state where the locking protrusion 22 is in contact with the locking wire 11, the tapered portion 22D comes into contact with the locking wire 11 from an insertion portion 25 side, as shown in FIG. 8.

Accordingly, in the state where the locking protrusion 22 is in contact with the locking wire 11, specifically, as shown in FIG. 8, the locking protrusion 22 is in contact with a right surface of the locking wire 11, the contact part 24 is in contact with a left surface of the locking wire 11, the abutment portion 21A is in contact with an upper surface of the locking wire 11, the insertion portion 25 is in contact with a lower surface of the locking wire 11, and the tapered portion 22D is in contact with a lower right surface of the locking wire 11.

It is noted that the locking protrusion 22 according to the present embodiment is provided on each of the one end side and the other end side along the pivot axis direction. Also, the tapered portion 22E is provided at the portion of each locking protrusion 22 corresponding to the leading end side of the pivot arm 21 in the extending directions of the pivot arm 21. The tapered portion 22E is a tapered part to be in contact with the locking wire 11 when the insertion portion 25 is inserted in the space 13.

### 3. Method of Using Locking System and Characteristics Thereof

### 3.1 Method of Use

The following describes a method of using the locking system 1 in a case in which the locking device 20 is provided on a lower surface of a cart (not shown), and the stud fitting 10, that is, the locking wire 11, is provided on a floor.

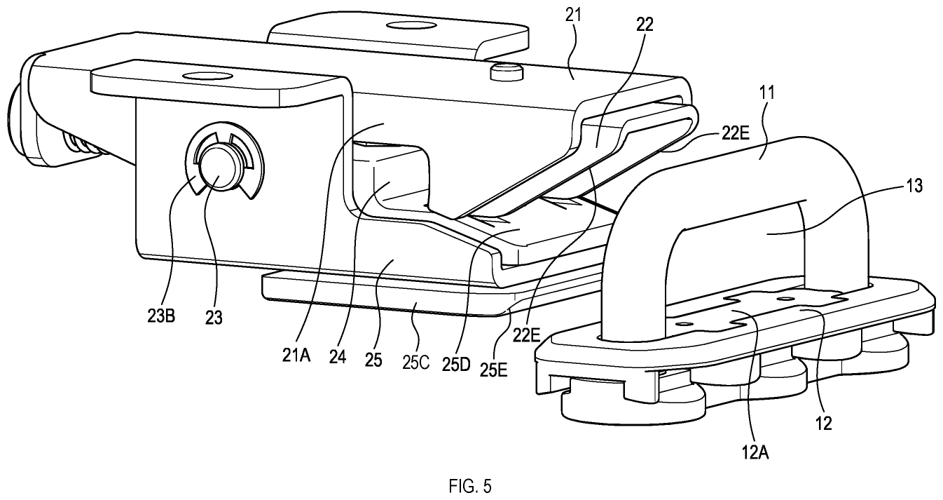

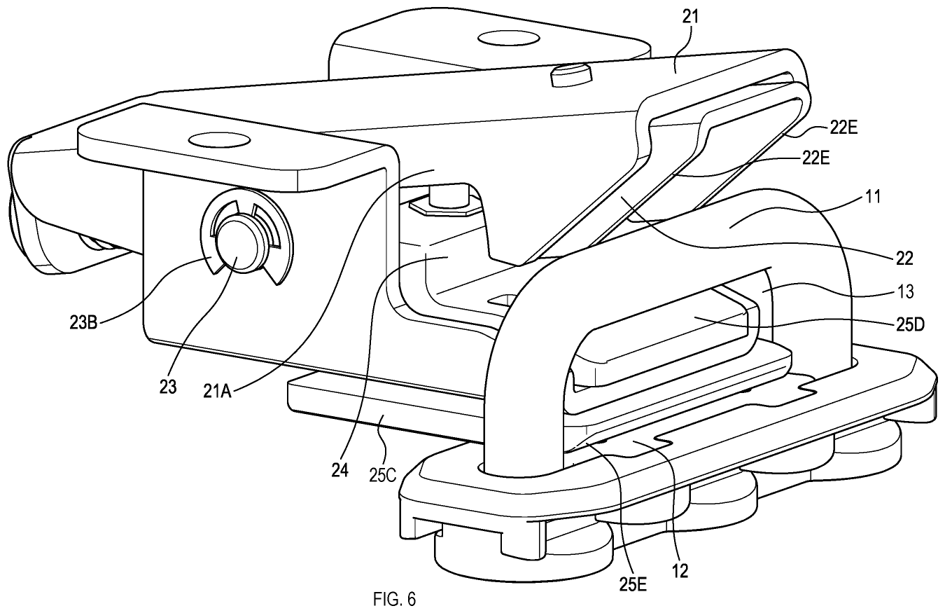

A user moves the cart such that the insertion portion 25 enters the space 13 (see FIG. 5). At this time, when the tapered portion 22E comes into contact with the locking wire 11, the tapered portion 22E and the locking wire 11 are brought into sliding contact with each other, causing the pivot arm 21 to pivot and to be displaced toward an upper side in FIG. 6 such that the pivot arm 21 moves away from the insertion portion 25, as shown in FIG. 6.

When the cart is further moved from the state shown in FIG. 6, the insertion portion 25 enters the space 13, and also the contact part 24 moves closer to the locking wire 11. Thereafter, when the contact part 24 comes into contact with the locking wire 11, the movement of the cart stops and the abutment portion 21A comes into contact with the locking wire 11 (see FIG. 3).

Next, the user rotates the position adjustment bolt 22A until the locking protrusion 22 comes into contact with the locking wire 11. This causes the locking wire 11 to be held by the contact part 24 and the locking protrusion 22 (see FIG. 3).

### 3.2 Features of Locking Device According to the Present Embodiment

According to the locking device 20 in the present embodiment, the locking wire 11 is held by the locking protrusion 22 and the contact part 24. Further, the locking protrusion 22 is contactable with the locking wire 11 in the direction opposite to the insertion direction by being displaced with respect to the pivot arm 21. Therefore, according to the locking device 20, the locking wire 11 is held securely by the locking protrusion 22 and the contact part 24, and thus rattling can be inhibited.

The tapered portion 22D protruding toward the contact part 24 is provided on the leading end side of the locking protrusion 22 in the protruding direction thereof. The tapered portion 22D is engaged with the insertion portion 25 side of the locking wire 11. Therefore, the pivot arm 21 is restricted from pivoting in the direction in which the leading end side of the pivot arm 21 moves away from the insertion portion 25, so that rattling can be reliably inhibited.

Furthermore, the insertion portion 25 is provided with the groove 25H in which the tapered portion 22D can be fitted. This allows the tapered portion 22D to be securely in contact with the locking wire 11 from the insertion portion 25 side.

The abutment portion 21A comes into contact with the locking wire 11 from the side opposite to the insertion portion 25 across the locking wire 11.

Thus, the locking wire 11 is held by the pivot arm 21, that is, the abutment portion 21A, and the insertion portion 25 in a direction intersecting the extending directions of the pivot arm 21. Accordingly, in the extending directions, the locking wire 11 is held by the locking protrusion 22 and the contact part 24. Therefore, an occurrence of rattling can be reliably inhibited.

### OTHER EMBODIMENTS

The locking wire 11 according to the above-described embodiment is configured to be fixed to a floor or the like via the fixing rail 2. However, the present disclosure is not limited to this configuration. Specifically, for example, the present disclosure may include a configuration where the locking wire 11 is directly fixed to a floor, a wall, or the like.

The above-described embodiment is an example in which the locking device is applied to the cart comprising a wheel such as a caster. However, the present disclosure is not limited to this configuration. Specifically, for example, the present disclosure may include a configuration where the locking device 20 is directly fixed to the article 3.

The insertion portion 25 according to the above-described embodiment comprises the slider 25C made of a resin. However, the present disclosure is not limited to this configuration. Specifically, for example, the present disclosure may include a configuration where the slider 25C is eliminated.

In the above-described embodiment, the locking protrusion 22 is configured to be displaced in conjunction with the rotation of the position adjustment bolt 22A. However, the present disclosure is not limited to this configuration. Specifically, the present disclosure may comprise, for example, instead of the position adjustment bolt 22A, a rotary handle or a quick-release lever used for mounting and dismounting a wheel of a bicycle.

In the above-described embodiment, the leading end side of the pivot arm 21 in its extending directions is provided with a tapered portion having a shape similar to that of the tapered portion 22E. However, the present disclosure is not limited to this configuration. Specifically, for example, the present disclosure may include a configuration where such a tapered portion having the similar shape may be eliminated.

In the above-described embodiment, the leading end side of the locking protrusion 22 in its protruding direction is provided with the tapered portion 22D having a triangular shape protruding toward the contact part 24. However, the present disclosure is not limited to this configuration. Specifically, for example, the present disclosure may include a configuration where the tapered portion 22D is eliminated.

In the above-described embodiment, the insertion portion 25 is provided with the groove 25H in which the tapered portion 22D can be fitted. However, the present disclosure is not limited to this configuration. Specifically, for example, the present disclosure may be a configuration where the groove 25H is eliminated.

Furthermore, the present disclosure only has to be consistent with the spirit of the recitation in the appended claims, and is not limited to the above-described embodiments. Accordingly, the present disclosure may include a configuration where at least two of the above-described embodiments are combined, or any of the elements in the above-described embodiments illustrated in the drawings or denoted with reference numerals may be eliminated.

What is claimed is:

1. A locking device lockable with a locking wire that is fixed to a fixing portion and that includes a portion arranged in a position spaced apart from the fixing portion, the locking device comprising:
an insertion portion configured to be inserted through a space between the locking wire and the fixing portion;
a pivot arm configured, in a state where the insertion portion is inserted through the space, to be located on a side opposite to the insertion portion across the locking wire and to extend parallel to an insertion direction of the insertion portion, the pivot arm being pivotable such that a leading end side of the pivot arm in extending directions thereof moves in directions to come closer to and to move away from the insertion portion;
a locking protrusion that is provided on a leading end side of the pivot arm and that protrudes toward the insertion portion, the locking protrusion being displaceable in directions parallel to the extending directions of the pivot arm;
a shaft configured to be located on a side opposite to the locking protrusion across the locking wire in the state where the insertion portion is inserted through the space, the shaft supporting the pivot arm in a pivotable manner; and
a contact part configured, in the state where the insertion portion is inserted through the space, to be located on the side opposite to the locking protrusion across the locking wire and to come into contact with the locking wire in the insertion direction,
wherein the locking protrusion is contactable with the locking wire in a direction opposite to the insertion direction by being displaced with respect to the pivot arm.

2. The locking device according to claim 1, wherein the locking protrusion is provided with, on a leading end side thereof in a protruding direction thereof, a tapered portion protruding toward the contact part.

3. The locking device according to claim 2, wherein the insertion portion is provided with a groove that allows the tapered portion to be fitted therein.

4. The locking device according to claim 1,
wherein the pivot arm comprises an abutment portion contactable with the locking wire, and
wherein the abutment portion is configured to come into contact with the locking wire from the side opposite to the insertion portion across the locking wire in the state where the insertion portion is inserted through the space.

5. The locking device according to claim 2,
wherein the pivot arm comprises an abutment portion contactable with the locking wire, and
wherein the abutment portion is configured to come into contact with the locking wire from the side opposite to the insertion portion across the locking wire in the state where the insertion portion is inserted through the space.

6. The locking device according to claim 3,
wherein the pivot arm comprises an abutment portion contactable with the locking wire, and
wherein the abutment portion is configured to come into contact with the locking wire from the side opposite to the insertion portion across the locking wire in the state where the insertion portion is inserted through the space.

7. A locking system, comprising:
a locking wire that is fixed to a fixing portion and that includes a portion arranged in a position spaced apart from the fixing portion;
an insertion portion configured to be inserted through a space between the locking wire and the fixing portion;
a pivot arm configured, in a state where the insertion portion is inserted through the space, to be located on a side opposite to the insertion portion across the locking wire and to extend parallel to an insertion direction of the insertion portion, the pivot arm being pivotable such that a leading end side of the pivot arm in extending directions thereof moves in directions to come closer to and to move away from the insertion portion;
a locking protrusion that is provided on a leading end side of the pivot arm and that protrudes toward the insertion portion, the locking protrusion being displaceable in directions parallel to the extending directions of the pivot arm;
a shaft configured to be located on a side opposite to the locking protrusion across the locking wire in the state where the insertion portion is inserted through the space, the shaft supporting the pivot arm in a pivotable manner; and
a contact part configured, in the state where the insertion portion is inserted through the space, to be located on the side opposite to the locking protrusion across the locking wire and to come into contact with the locking wire in the insertion direction,
wherein the locking protrusion is contactable with the locking wire in a direction opposite to the insertion direction by being displaced with respect to the pivot arm.
